(19) United States
(12) Patent Application Publication
(10) Pub. No.: US 2016/0007352 A1
(43) Pub. Date: Jan. 7, 2016

(54) CONTROLLING RESOURCES OF RADIO TERMINAL IN RADIO ACCESS NODE

(71) Applicant: TELEFONAKTIEBOLAGET L M ERICSSON (PUBL), Stockholm (SE)

(72) Inventors: Zhiwei QU, Shanghai (CN); Jueqi WANG, Shanghai (CN)

(73) Assignee: TELEFONAKTIEBOLAGET L M ERICSSON (PUBL), Stockholm (SE)

(21) Appl. No.: 14/768,739

(22) PCT Filed: Feb. 27, 2013
(86) PCT No.: PCT/CN2013/071925

§ 371 Date: Aug. 18, 2015

(51) Int. Cl. H04W 72/04; H04W 76/06

(52) U.S. Cl. CPC H04W 72/0453; H04W 72/0486; H04W 76/068

(57) ABSTRACT

A mobility management node and a corresponding method in the mobility management node for controlling resources of a radio terminal in a radio access node configured to operatively communicate user data between the radio terminal and a serving node, wherein the mobility management node is configured to operatively; initiate an establishment of resources in the radio access node so as to enable communication of user data, and initiate a releasement of established resources in the radio access node so as to disable the communication of user data. The method comprises the actions of: obtaining service information indicating the frequency of at least one of the establishments or the releasements, initiating an establishment of a new resource in the radio access node to enable a communication of user data between the radio terminal and the serving node, and determining an inactivation condition based on the service information.

### TECHNICAL FIELD

Exemplifying embodiments presented herein are directed towards a mobility management node and a corresponding method therein for controlling resources of a radio terminal in a radio access node configured to operatively communicate user data between the radio terminal and a serving node.

### BACKGROUND

With increased usage of Mobile Broadband and new user terminals such as smart-phones and tablets or similar, e.g. running Instant Messaging (IM) applications or similar, the signalling is increasing in the core network of modern cellular telecommunication systems. Much of the increased signalling is caused by user terminals switching between Idle and Connected state or similar. In a typically case the increased signalling is observed in the Evolved Packet Core (EPC) of the Long Term Evolution (LTE) as high rates of Service Requests and S1 connection releases or similar. The increased signalling is typically caused by the above mentioned IM applications and the like running on the new user terminals causing the terminal to send very short length of Packet Data Units (PDUs) and then release the radio connection to the core network, and then reconnect to the core network again when a new short length PDU is to be sent. Naturally, this causes a high signalling load with respect to the Mobility Management Entity (MME) and the Serving Gateway (SGW) in the EPC (Core Network), especially since a Direct Tunnel is mandatory between the MME and the SGW.

### SUMMARY

In view of the above there seems to be a need for an improvement with respect to the establishment and particularly with respect to the releasement of resources for a radio terminal so as to enable and disable communication respectively of user data between the radio terminal and the core network of a telecommunication system.

Embodiments of the present solution are based on the notion that a releasement of resources for a radio terminal can be advantageously delayed depending on the frequency of previous establishments and/or releasements of recourses for the radio terminal, e.g. such that a previous high frequency of establishments and/or releasements of recourses for a radio terminal indicates that a longer period should be used before releasing a new established resource, whereas a lower frequency of establishments and/or releasements of recourses indicates that a shorter period can be used before releasing a new established resource.

Using a longer period before releasing a new established resource at previous high frequency of establishments and/or releasements of recourses for a radio terminal increases the chance that the new resource is still established (i.e. not released) when the next use of the resource occurs, meaning that the resource does not have to be established again which reduces the signalling traffic in the core network of the communication system in question.

At least some drawbacks indicated above have been eliminated or at least mitigated by an embodiment of the present solution directed to a method in a mobility management node for controlling resources of a radio terminal in a radio access node configured to operatively communicate user data between the radio terminal and a serving node, wherein the mobility management node is configured to operatively; initiate an establishment of resources in the radio access node so as to enable communication of user data, and initiate a releasement of established resources in the radio access node so as to disable the communication of user data, wherein the method comprises the actions of: obtaining service information indicating the frequency of at least one of; the establishments or the releasements, and initiating an establishment of a new resource in the radio access node to enable a communication of user data between the radio terminal and the serving node, and determining an inactivation condition based on the service information, which inactivation condition enables the radio access node to determine a period after which the new resource is to be released, and providing the inactivation condition to the radio access node so as to initiate a release of the new resource.

At least some drawbacks indicated above have been eliminated or at least mitigated by an embodiment of the present solution directed to a mobility management node configured to operatively control resources of a radio terminal in a radio access node that is configured to operatively communicate user data between the radio terminal and a serving node, where the mobility management node is further configured to operatively; initiate an establishment of resources in the radio access node so as to enable communication of user data, and initiate a releasement of established resources in the radio access node so as to disable the communication of user data, where the mobility management node comprises processing circuitry configured to operatively: obtain service information indicating the frequency of at least one of; the establishments or the releasements, and initiate an establishment of a new resource in the radio access node to enable a communication of user data between the radio terminal and the serving node, and determine an inactivation condition based on the service information, which inactivation condition enables the radio access node to determine a period after which the new resource is to be released, and provide the inactivation condition to the radio access node so as to initiate a release of the new resource.

### BRIEF DESCRIPTION OF THE DRAWINGS

The foregoing will be apparent from the following more particular description of exemplifying embodiments, as illustrated in the accompanying drawings in which like reference characters refer to the same parts throughout the different views. The drawings are not necessarily to scale, emphasis instead being placed upon illustrating the exemplifying embodiments.

FIG. 1 is a schematic illustration of a well known exemplifying wireless communication system based on a LTE architecture,

FIG. 2 is a schematic illustration of another well known exemplifying wireless communication system based on a GPRS architecture,

FIG. 3 is a schematic illustration of a wireless communication system based on a LTE architecture,

FIG. 4 is a schematic illustration of a wireless communication system based on a GPRS architecture,

FIG. 5 is a schematic illustration of a mobility management node according to some embodiments of the present solution,

FIG. 6 is a flow diagram illustrating exemplifying operations that may be executed by at least some embodiments of the present solution,

FIG. 7 is a signaling diagram illustrating exemplifying messages that may be exchanged between nodes in a wireless communication system configured to implement at least some embodiments of the present solution.

### DETAILED DESCRIPTION

In the following description, for purposes of explanation and not limitation, specific details are set forth, such as particular components, elements, techniques, etc. in order to provide a thorough understanding of some exemplifying embodiments of the present solution. However, it will be apparent to those skilled in the art that the exemplifying embodiments may be practiced in other manners that depart from these specific details. In other instances, detailed descriptions of well-known methods and elements are omitted so as not to obscure the description of the exemplifying embodiments. The terminology used herein is for the purpose of describing the exemplifying embodiments and is not intended to limit the embodiments presented herein.

FIG. 1 shows a schematic overview of a well known exemplifying wireless communication system. The system is a so called LTE based system. It should be pointed out that the terms “LTE” and “LTE based” system is here used to comprise both present and future LTE based systems, such as, for example, advanced LTE systems.

It should be appreciated that although FIG. 1 shows a wireless communication system based on a LTE architecture, the example embodiments herein may also be utilized in connection with other wireless communication systems comprising nodes and functions that correspond to the nodes and functions of the system in FIG. 1.

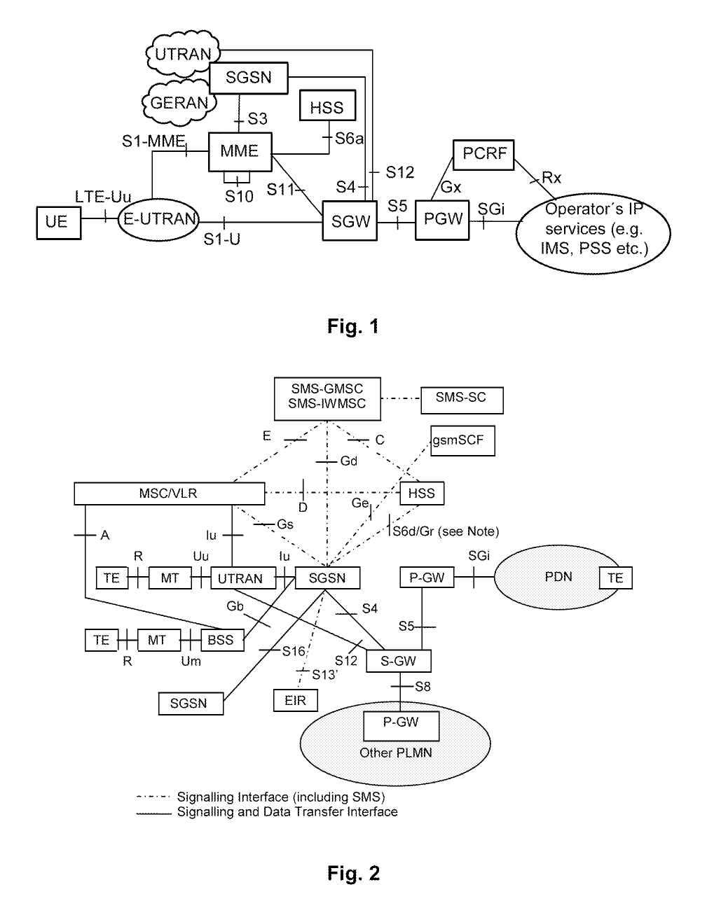

FIG. 2 shows a schematic overview of another exemplifying wireless communication system. The system is a well known exemplifying GPRS architecture.

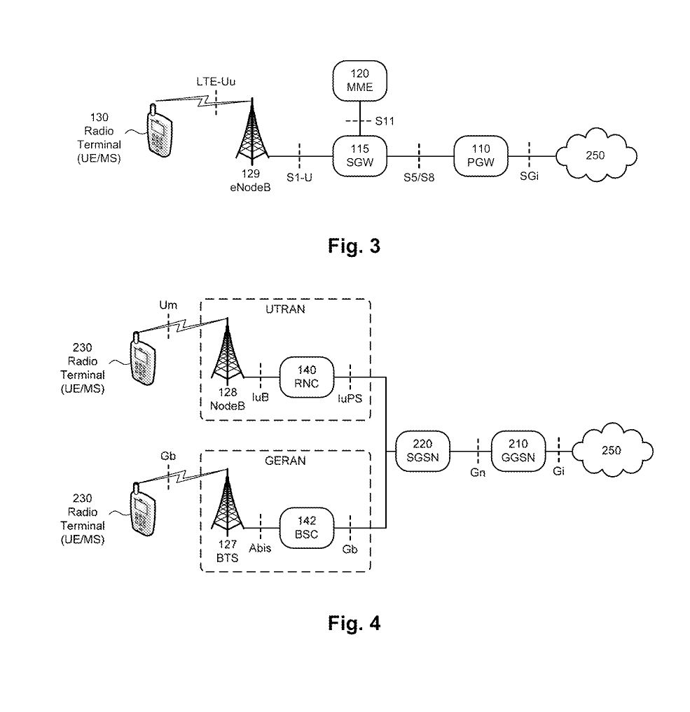

FIG. 3 shows another schematic illustration of a wireless communication system based on a LTE architecture. As can be seen, the system comprises a radio access node in the form of an eNodeB 129, connected to a Serving Gateway (SGW) 115, in turn connected to a Mobility Management Entity (MME) 120 and a PDN Gateway (PGW) 110.

The eNodeB 129 is a radio access node that interfaces with a radio terminal 130, which is denoted User Equipment (UE) in LTE. The eNodeBs of the system forms the radio access network E-UTRAN for LTE. In general, a radio access node may be any suitable radio access node that is configured to operatively route traffic via an air interface between one or more radio terminals and a communication network (typically the core network of the communication network), e.g. such as a LTE-based network or a GPRS-based network or similar cellular network.

The SGW 115 is a serving node that is configured to route and forward user data packets, while also acting as the mobility anchor for the user plane during inter-eNB handovers and as the anchor for mobility between LTE and other 3GPP technologies (terminating S4 interface and relaying the traffic between 2G/3G systems and PDN GW). For idle state UEs, the SGW terminates the DL data path and triggers paging when DL data arrives for the UE. It manages and stores UE contexts, e.g. parameters of the IP bearer service, network internal routing information. It also performs replication of the user traffic in case of lawful interception. It preferred that the SGW 115 is configured to operatively act as an interface between the internal IP network of the LTE-based system in FIG. 3 (mainly the core network) and the radio access network or similar (e.g. including eNodeB:s etc as described above or similar). It is preferred that the SGW 115 is configured to operatively communicate user plane data or similar payload data flowing between one or more radio terminals or similar—e.g. the UE 130 or similar—and the PGW 110. This may e.g. include at least one of; tunneling of user plane data, establishing, modifying and/or releasing bearers etc for the UE 130 or similar. Payload data may be seen as the actual user data intended to be received by a final destination, e.g. the radio terminal such as the UE 130. For example, user data may be seen as the part of a data packet that remains when the packet header has been removed. User plane data or similar payload is typically distinct from control plane data.

The MME 120 is a mobility management node configured to act as the key control-node for the LTE access-network. It is responsible for idle mode UE tracking and paging procedure including retransmissions. It is involved in the bearer activation/deactivation process and is also responsible for choosing the SGW for a UE at the initial attach and at time of intra-LTE handover involving Core Network (CN) node relocation. It is responsible for authenticating the user (by interacting with the HSS). The Non-Access Stratum (NAS) signaling terminates at the MME and it is also responsible for generation and allocation of temporary identities to UEs. It checks the authorization of the UE to camp on the service provider's Public Land Mobile Network (PLMN) and enforces UE roaming restrictions. The MME is the termination point in the network for ciphering/integrity protection for NAS signaling and handles the security key management. Lawful interception of signaling is also supported by the MME. The MME also provides the control plane function for mobility between LTE and 2G/3G access networks with the S3 interface terminating at the MME from the SGSN. The MME also terminates the S6a interface towards the home HSS for roaming UEs

The PGW 110 is a network gateway node configured to provide connectivity to the UE to external packet data networks 250 by being the point of exit and entry of traffic for the UE. A UE may have simultaneous connectivity with more than one PGW for accessing multiple PDNs. The PGW performs policy enforcement, packet filtering for each user, charging support, lawful Interception and packet screening. Another key role of the PGW is to act as the anchor for mobility between 3GPP and non-3GPP technologies such as WiMAX and 3GPP2 (CDMA 1X and EvDO).

FIG. 4 shows another schematic illustration of a wireless communication system based on a GPRS architecture. As can be seen, the system comprises a Gateway GPRS Support Node (GGSN) 210 connected to a Serving GPRS Support Node (SGSN) 220. In turn, the SGSN is connected to a Radio Network Controller (RNC) 140 that is connected to a base station in the form of a NodeB 128, and to a Base Station Controller (BSC) 142 that is connected to a base station in the form of a Base Transceiver Station (BTS) 127.

The GGSN 210 is a main component of the GPRS network. The GGSN 210 is responsible for the interworking between the GPRS network and external packet data networks 250, like the Internet and X.25 networks. The GGSN 210 is the anchor point that enables the mobility of the user terminal in the GPRS/UMTS networks and it may be seen as the GPRS equivalent to the Home Agent in Mobile IP. It maintains routing necessary to tunnel the Protocol Data Units (PDUs) to the SGSN 220 that services a particular Mobile Station (MS). The GGSN 210 converts the GPRS packets coming from the SGSN 220 into the appropriate packet data protocol (PDP) format (e.g., IP or X.25) and sends them out on the corresponding packet data network. In the other direction, PDP addresses of incoming data packets are converted to the GSM address of the destination user. The readdressed packets are sent to the responsible SGSN 220. The GGSN 210 is responsible for IP address assignment and is the default router for the connected user equipment (UE). The GGSN 210 also performs authentication and charging functions. Other functions include subscriber screening, IP Pool management and address mapping, QoS and PDP context enforcement.

The SGSN 220 is a serving node responsible for the delivery of data packets from and to the radio terminals such as mobile stations (MS:s) within its geographical service area. Its tasks include packet routing and transfer, mobility management (attach/detach and location management), logical link management, and authentication and charging functions. The location register of the SGSN 220 stores location information (e.g., current cell, current Visitor Location Register (VLR)) and user profiles (e.g., International Mobile Station Identity (IMSI), address(es) used in the packet data network) of all GPRS users registered with this SGSN.

The RNC 140 is a node in the UMTS radio access network (UTRAN) and is responsible for controlling the NodeBs that are connected to it. A NodeB is a radio access node of the similar kind as the above mentioned eNodeB. One exemplifying NodeB 128 serving radio terminal 230 in the form of an UE or a MS has been indicated in FIG. 4. The RNC 140 carries out radio resource management, some of the mobility management functions and is the point where encryption is done before user data is sent to and from the mobile. The RNC 140 connects to the SGSN 220 in the Packet Switched Core Network.

The BSC 142 is a node in the GSM Radio Access Network (GERAN) and is responsible for controlling the Base Station Transceivers (BTSs) that are connected to it. A BTS is a radio access node of the similar kind as the above mentioned eNodeB and NodeB. One exemplifying BTS 127 serving a radio terminal 230 in the form of an UE or a MS has been indicated in FIG. 4. The BSC 142 carries out radio resource management and some of the mobility management functions.

As can be seen in FIGS. 3 and 4, there are radio terminals such as UEs and/or MSs that communicate with the eNodeB and/or the RNC via a NodeB and/or the BSC via a BTS using an air interface such as LTE-Uu, Um and Gb interface respectively. This makes it possible for the radio terminals to access resources provided by the core network of the systems respectively. A skilled person having the benefit of this disclosure realizes that vast number of well known radio terminals can be used in the various embodiments of the present solution. The radio terminal may e.g. be a cell phone device or similar, e.g. such as a Mobile Station (MS) or a User Equipment (UE) or similar, e.g. defined by the standards provided by the 3GPP. Thus, the radio terminal needs no detailed description as such. However, it should be emphasized that the mobile radio terminals may be embedded (e.g. as a card or a circuit arrangement or similar) in and/or attached to various other devices, e.g. such as various laptop computers or tablets or similar or other mobile consumer electronics or similar, or vehicles or boats or air planes or other movable devices, e.g. intended for transport purposes. Indeed, the radio terminal may even be embedded in and/or attached to various semi-stationary devices, e.g. domestic appliances or similar, or consumer electronics such as printers or similar having a semi-stationary mobility character.

The notations S1-U, IuB, Abis, IuPS, Gb, S5/S8, S11, SGi, Gn and Gi indicated in FIGS. 3 and 4 represent various well known interfaces or similar defined in the 3GPP standards and they need no further explanation as such.

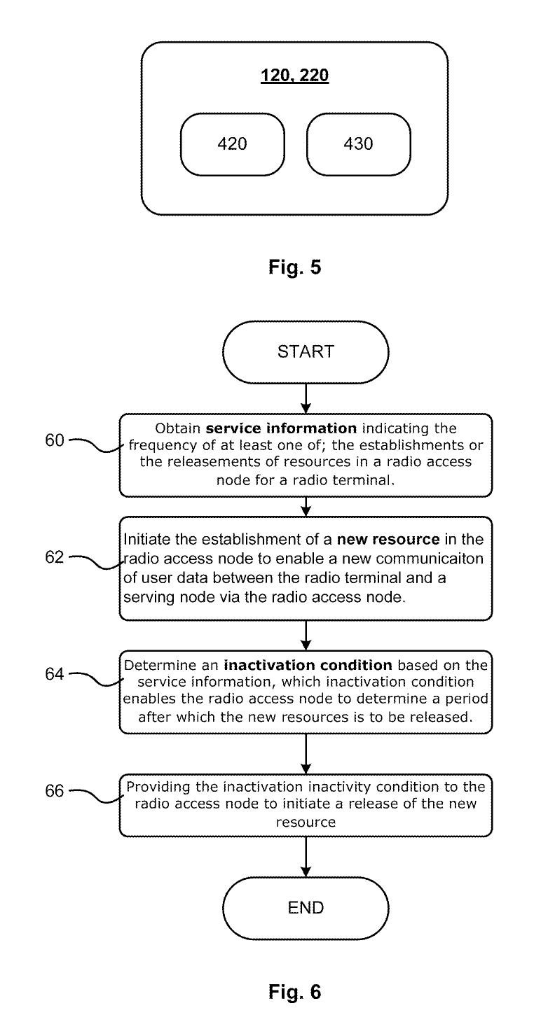

FIG. 5 shows some interior parts of a mobility management node e.g. such as the MME 120 or the SGSN 220 being relevant to the example embodiments described herein. As can be seen, the mobility management node may comprise processing circuitry 420 and a memory unit 430. The processing circuitry 420 may e.g. comprise signal processing circuitry and/or logic circuitry and/or interfacing circuitry as required by the embodiments described herein. In particular embodiments, some or all of the functionality described herein as being provided by a mobility management node or similar may be provided by the processing circuitry 420, e.g. executing appropriate operations and/or actions based on instructions e.g. stored on a computer-readable medium, such as the memory unit 430 shown in FIG. 5. Alternative embodiments of the mobility management node may comprise additional components responsible for providing additional functionality, comprising any of the functionality identified herein and/or any functionality necessary to support the example embodiments described herein.

### Operation of Exemplifying Embodiments

The attention is now directed to the operation of exemplifying embodiment and wireless communication systems, e.g. as discussed with reference to FIGS. 3 and 4, wherein some embodiments of the present solution may be executed.

FIG. 6 illustrates a flow diagram depicting exemplifying operations which may be performed by a mobility management node, e.g. the MME 120 or the SGSN 220 discussed above with reference to FIGS. 3 and 4 respectively. The operations provides a method in the mobility management node for controlling resources in a radio access node configured to operatively communicate a communication of user data between a radio terminal and a serving node. It is preferred that mobility management node is configured to operatively manage the mobility of the radio terminal. The radio access node may e.g. be an eNodeB a NodeB or a BTS or similar base station. The radio terminal may e.g. be a UE or MS as indicated above or any other cellular device or radio device or similar. The serving node may e.g. be a SGW or a SGSN as indicated above. The user data may e.g. be data transported in the “user plane” (i.e. user plane data), which is commonly known as such by those skilled in the art and which is also defined as such in the 3GPP standards. It is preferred that the mobility management node is configured to operatively initiate an establishment of resources in the radio access node so as to enable a communication of user data, and initiate a releasement of established resources in the radio access node so as to disable the communication of user data. The resources to be established and released for the radio terminal may e.g. be an Evolved Packet System bearer (EPS bearer) in LTE or a Packet Data Protocol context (PDP context) in UMTS/GPRS or similar. The properties and functions of PDP contexts and EPS bearers are well known by those skilled in the art and they need no further explanation as such. However, it may be briefly mentioned that an EPS bearer and PDP context may e.g. be seen as the establishment of a “virtual” connection between two endpoints (e.g. a UE and a PGW) before any traffic can be sent between the endpoints.

### Example Operation 60:

The mobility management node may be configured to operatively obtain service information indicating the frequency of at least one of; the establishments or the releasements of resources for a radio terminal served by the mobility management node.

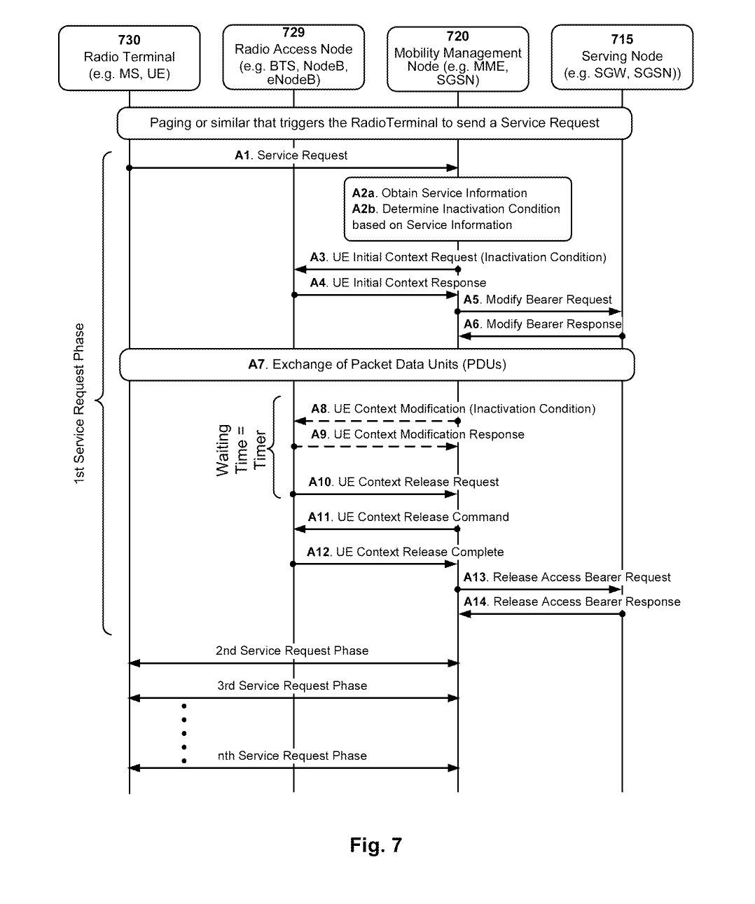

The service information may generally be obtained based on various actions occurring during the establishment or releasement of resources for the radio terminal, e.g. based on at least one of; the occurrence of actions A1, A3, A4, A5, A6, A8, A9, A10, A11, A12, A13 and/or A14 as will be discussed below with reference to FIG. 7. Thus, operation 60 may be performed based on any suitable action that indicates an establishment and/or releasement of resources for the radio terminal. Thus, operation 60 may e.g. be performed in connection with and/or after any of said actions A1, A3, A4, A5, A6, A8, A9, A10, A11, A12, A13 and/or A14 or similar.

It should be emphasised that one or more establishments and/or releasements of resources for the radio terminal may have occurred before the occurrence of the specific operation 60 now discussed. Such previous establishments and/or releasements of resources for the radio terminal may be taken into account when obtaining the service information under this operation 60.

### Example Operation 62

The mobility management node may be configured to operatively initiate an establishment of a new resource for the radio terminal in a radio access node to enable a new communication of user data between the radio terminal and a serving node via the radio access node, e.g. enable the communication of a stream of user data. The resources may e.g. be one ore more EPS bearers or a PDP contexts or similar.

### Example Operation 64:

The mobility management node may be configured to operatively determine an inactivation condition based on the service information, which inactivation condition enables the radio access node to determine a period after which the new resources is to be released. The inactivation condition may e.g. be an inactivity timer indication a period after which the radio access node is supposed to release the new recourses.

The new resource may e.g. be released a period after the establishment of the new resource, or after a period during which the new resource has not bee used, e.g. a period after which the last amount of user data was communicated via the new resource.

### Example Operation 66:

The mobility management node may be configured to operatively provide the inactivation information indicating the inactivity condition to the radio access node to initiate a release of the new resources.

FIG. 7 is a signaling diagram illustrating some exemplifying messages that may be transmitted and/or received by nodes implementing at least some embodiments of the present solution. FIG. 7 shows a radio terminal 730, a radio access node 729, a mobility management node 720 and a gateway node 710 of the same or similar kind as previously discussed above with reference to FIGS. 3 and 4. Thus, the radio terminal 730 may e.g. be a UE or a MS or similar. The radio access node 729 may e.g. be a base station, e.g. such as a BTS or a NodeB or an eNodeB or similar. The mobility management node 720 may e.g. be a MME or SGSN or similar, and the serving node 715 may e.g. be a SGW or a SGSN or similar.

The signalling diagram of FIG. 7 illustrates various action performed by the nodes 730, 729, 720, 715 and messages sent between the nodes 730, 729, 720, 715 as will be elaborated in some detail below. It should be appreciated that the messages and actions elaborated below are a non-limiting examples. Some embodiments of the present solution may comprise additional messages and some other embodiments may not use all the messages indicated in FIG. 7. Some embodiments may send and/or receive the messages and/or perform various actions in a different order compared to the one indicated in FIG. 7.

As can be seen in FIG. 7 the first action A1 may be proceeded by one or more actions performed by and/or messages communicated between the radio terminal 730 on one hand and on the other hand the radio access node 729 being a part of a radio access network and/or the mobility management node 720 and/or the serving node 715 being parts of a core network, e.g. such as an Evolved Packet Core (EPC) or similar packet core network.

It is preferred that the actions and/or messages proceeding action A1 are such that the mobility management node 720 will initiate an establishment of resources in the radio access node 729 so as to enable a communication of user data between the radio terminal 730 and the serving node 715 as will be discussed below with reference to Action A3 and forward. The resources to be established for the radio terminal 730 may e.g. be one or more Evolved Packet System bearers (EPS bearer) or Packet Data Protocol contexts (PDP context) or similar.

### Action A1

The mobility management node 720 may be configured to operatively receive a request for a new resource in a message sent from the radio terminal 730 via the radio access node 729. The message may be sent via one or more other nodes or similar. The radio terminal 730 may have initiated this message, or the radio terminal 730 may have been initiated by the core network to send this message, e.g. initiated by the mobility management node 720. The message received by the mobility management node 720 from the radio terminal 730 may e.g. be a Service Request message or similar. The Service Request may e.g. be initiated by the radio terminal 730 for sending Uplink payload to the core network, or initiated by the core network for sending Downlink payload to the radio terminal 730, e.g. resulting in a Service Request as paging response from the radio access node 729.

Action A1 is one way of performing operation 62 discussed above with reference to the flowchart in FIG. 6.

### Action A2a

The mobility management node 720 may be configured to operatively obtain service information indicating the frequency of at least one of; the establishments of resources for the radio terminal 720 served by the mobility management node 720 or the releasements of resources for the radio terminal 720 served by the mobility management node 720.

The service information may e.g. be obtained based on at least one of; the number of establishments or the number of releasements of resources during a predetermined period.

The number of establishments may e.g. be determined by measuring at least one of; the number of received requests for new resources indicated above when discussing Action A1, or the number of initiations sent by the mobility management node 720 to the radio access node 729 as will be discussed below with reference to Action A3, or the number of initiation responses received by the mobility management node 720 from the radio access node 729 as will be discussed below with reference to Action A4, or the number of modify resource requests sent by the mobility management node 720 to the serving node 715 as will be discussed below with reference to Action A5, or the number of modify resource responses received by the mobility management node 720 from the serving node 715 as will be discussed below with reference to Action A6, or the number of modify resource sent by the mobility management node 720 to the radio access node 729 as will be discussed below with reference to Action A8, or the number of modify resource responses received by the mobility management node 720 from the radio access node 729 as will be discussed below with reference to Action A9.

The number of releasements may e.g. be determined by measuring at least one of; the number of release resource message received by the mobility management node 720 from the radio access node 729 as will be discussed below with reference to Action A10, or the number of release commands sent by the mobility management node 720 to the radio access node 729 as will be discussed below with reference to Action A11, or the number of release completes received by the mobility management node 720 from the radio access node 729 as will be discussed below with reference to Action A12, or the the number of release access bearer requests sent by the mobility management node 720 to the serving node 715 as will be discussed below with reference to Action A13, or the number of release access bearer responses received by the mobility management node 720 from the serving node 715 as will be discussed below with reference to Action A14.

A person skilled in the art having the benefit of this disclosure realises that the service information may generally be obtained based on various actions occurring during the establishment or releasements of resources for the radio terminal 730, e.g. based on at least one of; the occurrence of actions A1, A3, A4, A5, A6, A8, A9, A10, A11, A12, A13 and/or A14. Thus, action A2 may be performed after any suitable action that may serve as a basis for obtaining the service information. Thus, action A2 must not be performed after action A1 as indicated in the signalling diagram of FIG. 7. On the contrary, action A2 may e.g. be performed after any of actions A1, A3, A4, A5, A6, A8, A9, A10, A11, A12, A13 and/or A14.

Here it should be emphasised that one or more establishments and/or releasements of resources for the radio terminal 720—e.g. indicated by actions such as A1, A3, A4, A5, A6, A8, A9, A10, A11, A12, A13 and/or A14—may have occurred before the occurrence of the specific action A1 illustrated in the signalling diagram of FIG. 7 now discussed. Such previous establishments and/or releasements may be taken into account when obtaining the service information under this action A2a.

Action A2a is one way of performing operation 60 discussed above with reference to the flowchart in FIG. 6.

### Action A1b

The mobility management node 720 may be configured to operatively determine an inactivation condition based on the service information obtained in action A2a described above. The inactivation condition is intended to be used by the radio access node 729 to determine a period after which a newly established resource for the radio terminal 730 is to be released by the radio access node 729. The inactivation condition may e.g. indicate a period after which a newly established resource is to be released by the radio access node 729. The inactivation condition may e.g. indicate a User Inactivity Timer or similar as defined in the 3GPP standards. The period after which a new resource is to be released may e.g. start counting when the new resource is established, e.g. after action A4 or action A6 as will be described in more detail below, or after action A7 indicating that the communication of user data—e.g. Packet Data Units (PDUs)—has stopped via the new resource between the radio terminal 730 and the serving node 715, e.g. in the same or similar manner as defined in the 3GPP with respect to the User Inactivity Timer.

It should be added that in case the service information indicates a low number of establishments and/or releasements during the predetermined period, e.g. less than two (2), or less than three (3) or less than four (4) or less than five (5) or less than ten (10), then it may be preferred to use a predetermined default value for the inactivation condition, e.g. based on empirical knowledge. However, once the number of establishments and/or releasements increases during a predetermined period it will be possible to more accurately determine the frequency of the establishments and/or the releasements during the period and then it is preferred that the inactivation condition is based on the frequency of the establishments and/or the releasements as indicated above.

Generally, when the service information corresponds to a frequency of establishments and/or releasements of resources that is above an upper threshold then it is preferred that the inactivation condition is determined such that it indicates a longer period. Conversely, when the service information corresponds to a frequency of establishments and/or releasements of resources that is below a lower threshold then it is preferred that the inactivation condition is determined such that it indicates a shorter period. The upper and lower threshold may be one and the same threshold. When the upper and the lower thresholds are two different thresholds then it is preferred that the inactivation condition is kept unchanged when the service information corresponds to a frequency of establishments and/or releasements of resources that is between the upper threshold and the lower threshold. The thresholds now discussed may e.g. be predetermined thresholds, e.g. predetermined based on empirical investigations.

Action A2b is one way of performing operation 64 discussed above with reference to the flowchart in FIG. 6.

### Action A3

The mobility management node 720 may be configured to operatively send an initiation of a new resource for the radio terminal 730 to the radio access node 729. The initiation may e.g. be sent in a request message, e.g. an initiation request message. The initiation message may e.g. be an UE Initial Context Request message or similar as defined in the 3GPP standards. It is preferred that the initiation—e.g. the initiation request message or the UE Initial Context Request message or similar—comprises the inactivation condition determined in action A2b described above. The inactivation condition may e.g. be a User Inactivity Timer as discussed in action A2b above. The new resource in the radio access node 729 enables a communication of user data to be sent between the radio terminal 730 and the serving node 715 via the radio access node 729.

Action A3 is one way of performing operation 66 discussed above with reference to the flowchart in FIG. 6.

### Action A4

The mobility management node 720 may be configured to operatively receive an initiation response from the radio access node 729. The initiation response may e.g. be sent in an initiation response message, e.g. in an UE Initial Context Response message or similar as defined in the 3GPP standards.

### Action A5

The mobility management node 720 may be configured to operatively send a modify resource request message to the serving node 715, e.g. a Modify Bearer Request message or similar as defined in the 3GPP standards.

### Action A6

The mobility management node 720 may be configured to operatively receive a modify resource response message from the serving node 715, e.g. a Modify Bearer Response message or similar as defined in the 3GPP standards. In this embodiment it is preferred that the sixth action A6 finalises the establishment of the new resource requested in action A1. However, a skilled person having the benefit of this disclosure realizes that a new resource may be established in the radio access node 729 in many different well known manners so as to enable a communication of user data to be sent between the radio terminal 730 and the serving node 715 via the radio access node 729.

### Action A7

In a seventh action A7 it is preferred that user data is communicated between the radio terminal 730 and the serving node 715 via the radio access node 729 while using the newly established resource in the radio access node 729.

### Action A8

The mobility management node 720 may be configured to operatively send a modify resource message to the radio access node 729 at any while the radio terminal is served by the mobility management node 720, i.e. not only as a response to a certain activity, e.g. sending an UE Initial Context Request message as a response to a Service Request message as indicated in action A3. The modify resource message may e.g. be an UE Context Modification message or similar as defined in the 3GPP standards. It is preferred that the modify resource message—e.g. the UE Context Modification message or similar—comprises the inactivation condition. The inactivation condition may e.g. be a User Inactivity Timer as discussed in action A2b above. The inactivation condition is preferably determined as described in action A2b above. However, other behaviours of the radio terminal 730 may be taken into consideration at this stage, and the determination of the inactivation condition may be taken after or before action A1, e.g. during or after the communication of user data according to action A7.

MME could optionally modify the User Inactivity Timer after the detection and measurement of the UE behavior by sending “UE Context Modification Request” towards eNB.

### Action A9

The mobility management node 720 may be configured to operatively receive a modify resource response message from the radio access node 729 as a response to the modify resource message sent in action A8. The modify resource response message may e.g. be an UE Context Modification Response message or similar as defined in the 3GPP standards.

### Action A10

Once the radio terminal 730 has no more user data to communicate in action A7 via the newly established resource, the radio access node 729 may wait for the time indicated by the inactivation condition determined in action A2b and provided to the radio access node 729 in action A3. Then, provided that there is still no such user data to be communicated, the mobility management node 720 may receive a release resource message from the radio access node 729, indicating that the newly established resource is to be released. The release resource message may e.g. be a UE Context Release Request message or similar as defined in the 3GPP standards.

In some embodiments the same may apply once the serving node 715 has no more data to communicate to the radio terminal 730 in action A7 via the newly established resource. The radio access node 729 may then wait for the time indicated by the inactivation condition determined in action A2b and provided to the radio access node 729 in action A3. Then, the mobility management node 720 may receive a release resource message from the radio access node 729. The release resource message may e.g. be a UE Context Release Request message or similar as defined in the 3GPP standards.

### Action A11

The mobility management node 720 may be configured to operatively send a release command message to the radio access node 729 as a response to the release resource message received in action A10, indicating that the newly established resource shall be released by the radio access node 729. The release command message may e.g. be a UE Context Release Command message or similar as defined in the 3GPP standards.

### Action A12

The mobility management node 720 may be configured to operatively receive a release complete message from the radio access node 729 as a response to the release command message sent in action A11, indicating that the new resource has been released or will be released shortly. The release complete message may e.g. be a UE Context Release Complete message or similar as defined in the 3GPP standards.

### Action A13

The mobility management node 720 may be configured to operatively send a release resource message to the serving node 715 as a response to the release complete message received in action A12, indicating that the new resource established in the serving node 715 for the terminal as discussed in actions A1 to A6—particularly actions A5 and A6—shall be released by the serving node 715. The release resource message may e.g. be a Release Access Bearer Request message or similar as defined in the 3GPP standards.

### Action A14

The mobility management node 720 may be configured to operatively receive a release resource response message from the serving node 715 as a response to the release resource message sent in action A13, indicating that the new resource has been released or will be released shortly. The release resource response message may e.g. be a Release Access Bearer Response message or similar as defined in the 3GPP standards.

The exemplifying actions A1 to A14 discussed above may be seen a one service request phase comprising an establishment and a releasement of a new resource for the radio terminal. The service request phase may be the first service request phase followed by a number n of other service request phases of the same or similar kind. In addition or alternatively, the service request phase now described may have been preceded by a number n of other service request phases of the same or similar kind as now described. This was briefly touched upon above when discussing operation 60 and the obtainment of service information. There it was concluded that one or more establishments and/or releasements of resources for the radio terminal may have occurred before operation 60 and that such previous establishments and/or releasements of resources for the radio terminal may indeed be taken into account when obtaining the service information under operation 60.

### Some Embodiments Described Herein may be Summarized in the Following Manner:

One embodiment is directed to a method in a mobility management node for controlling resources of a radio terminal in a radio access node configured to operatively communicate user data between the radio terminal and a serving node. The mobility management node is configured to operatively; initiate an establishment of resources in the radio access node so as to enable communication of user data, and initiate a releasement of established resources in the radio access node so as to disable the communication of user data.

The method comprises the actions of: obtaining service information indicating the frequency of at least one of; the establishments or the releasements; initiating an establishment of a new resource in the radio access node to enable a communication of user data between the radio terminal and the serving node; determining an inactivation condition based on the service information, which inactivation condition enables the radio access node to determine a period after which the new resource is to be released; providing the inactivation condition to the radio access node so as to initiate a release of the new resource.

The service information may be obtained based on at least one of: the number of establishments or the number of releasements during a predetermined period.

Alternatively or additionally, the service information may be obtained based on at least one of:
the number of establishments indicated by at least one of; the number of Service

Request messages received by the mobility management node from the radio terminal node, or the number of UE Initial Context Request messages sent be the mobility management node to the radio access node, or the number of UE Initial Context Response messages received by the mobility management node from the radio access node, or the number of UE Context Modification messages sent by the mobility management node to the radio access node, or the number of UE Context Modification Response messages received by the mobility management node from the radio access node during the predetermined period; or
the number of releasements indicated by at least one of; the number of UE Context Release Request messages received by the mobility management node from the radio access node, or the number of UE Context Release Command messages sent by the mobility management node to the radio access node, or the number of UE Context Release Complete messages received by the mobility management node from the radio access node, or the number of Release Access Bearer Request messages sent by the mobility management node to the serving node, or the number of Release Access Bearer Response messages received by the mobility management node from the serving node.

The messages mentioned above are commonly used messages that are defined by the 3GPP standards. The use of messages defined in the 3GPP standards means that the mobility management node (e.g. in case of an MME or even a SGSN or similar) may utilize existing messages to perform the method, i.e. no new dedicated messages has to be introduced to accomplish the method in this respect. This is an advantage compared to mobility management nodes that utilize dedicated non-standardised messages to accomplish a certain method.

The inactivation condition is preferably determined such that the inactivation condition indicates an increased period when the service information corresponds to a frequency above a predetermined first threshold, and determined such that the inactivation condition indicates a decreased period when the service information corresponds to a frequency below a predetermined second threshold being lower than or equal to the first threshold. Here, the first and the second threshold may be the same threshold or two different thresholds.

Additionally or alternatively, the inactivation condition may be determined such that the inactivation condition indicates an unchanged period when the service information corresponds to a frequency between the predetermined first threshold and the predetermined second threshold being lower than the first threshold. Here it is assumed that the first and the second threshold are two different thresholds.

It is preferred that the inactivation condition indicates a User Inactivity Timer.

### Some Other Embodiments Described Herein may be Summarized in the Following Manner:

One other embodiment is directed to a mobility management node configured to operatively control resources of a radio terminal in a radio access node that is configured to operatively communicate user data between the radio terminal and a serving node, where the mobility management node is further configured to operatively; initiate an establishment of resources in the radio access node so as to enable communication of user data, and initiate a releasement of established resources in the radio access node so as to disable the communication of user data.

The mobility management node comprises processing circuitry configured to operatively: obtain service information indicating the frequency of at least one of; the establishments or the releasements; initiate an establishment of a new resource in the radio access node to enable a communication of user data between the radio terminal and the serving node; determine an inactivation condition based on the service information, which inactivation condition enables the radio access node to determine a period after which the new resource is to be released, provide the inactivation condition to the radio access node so as to initiate a release of the new resource.

The processing circuitry may be configured to operatively obtain the service information based on at least one of: the number of establishments or the number of releasements during a predetermined period.

Additionally or alternatively, the processing circuitry may be configured to operatively obtain the service information based on at least one of:
the number of establishments indicated by at least one of; the number of Service

Request messages received by the mobility management node from the radio terminal node, or the number of UE Initial Context Request messages sent be the mobility management node to the radio access node, or the number of UE Initial Context Response messages received by the mobility management node from the radio access node, or the number of UE Context Modification messages sent by the mobility management node to the radio access node, or the number of UE Context Modification Response messages received by the mobility management node from the radio access node during the predetermined period; or
the number of releasements indicated by at least one of; the number of UE Context Release Request messages received by the mobility management node from the radio access node, or the number of UE Context Release Command messages sent by the mobility management node to the radio access node, or the number of UE Context Release Complete messages received by the mobility management node from the radio access node, or the number of Release Access Bearer Request messages sent by the mobility management node to the serving node, or the number of Release Access Bearer Response messages received by the mobility management node from the serving node.

It is preferred that the processing circuitry is configured to operatively determine the inactivation condition such that the inactivation condition indicates an increased period when the service information corresponds to a frequency above a predetermined first threshold, and determine the inactivation condition such that the inactivation condition indicates a decreased period when the service information corresponds to a frequency below a predetermined second threshold being lower than or equal to the first threshold. Here, the first and the second threshold may be the same threshold or two different thresholds.

Additionally or alternatively, the processing circuitry may be configured to operatively determine the inactivation condition such that the inactivation condition indicates an unchanged period when the service information corresponds to a frequency between the predetermined first threshold and the predetermined second threshold being lower than the first threshold. Here it is assumed that the first and the second threshold are two different thresholds.

It is preferred that the inactivation condition indicates a User Inactivity Timer.

The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that any of the example embodiments presented herein may be used in conjunction, or in any combination, with one another.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the example embodiments, that the example embodiments may be implemented at least in part by means of both hardware and software, and that several “means”, “units” or “devices” may be represented by the same item of hardware.

### ABBREVIATIONS

S1-MME:Reference point for the control plane protocol between E-UTRAN and MME.

S1-U: Reference point between E-UTRAN and Serving GW for the per bearer user plane tunnelling and inter eNodeB path switching during handover.

S3: It enables user and bearer information exchange for inter 3GPP access network mobility in idle and/or active state.

S4: It provides related control and mobility support between GPRS Core and the 3GPP Anchor function of Serving GW. In addition, if Direct Tunnel is not established, it provides the user plane tunnelling.

S5: It provides user plane tunnelling and tunnel management between Serving GW and PDN GW. It is used for Serving GW relocation due to UE mobility and if the Serving GW needs to connect to a non-collocated PDN GW for the required PDN connectivity.

S6a: It enables transfer of subscription and authentication data for authenticating/authorizing user access to the evolved system (AAA interface) between MME and HSS.

Gx: It provides transfer of (QoS) policy and charging rules from PCRF to Policy and Charging Enforcement Function (PCEF) in the PDN GW.

S8: Inter-PLMN reference point providing user and control plane between the Serving GW in the VPLMN and the PDN GW in the HPLMN. S8 is the inter PLMN variant of S5.

S9: It provides transfer of (QoS) policy and charging control information between the Home PCRF and the Visited PCRF in order to support local breakout function.

S10: Reference point between MMEs for MME relocation and MME to MME information transfer.

S11: Reference point between MME and Serving GW.

S12: Reference point between UTRAN and Serving GW for user plane tunnelling when Direct Tunnel is established. It is based on the Iu-u/Gn-u reference point using the GTP-U protocol as defined between SGSN and UTRAN or respectively between SGSN and GGSN. Usage of S12 is an operator configuration option.

S13: It enables UE identity check procedure between MME and EIR.

SGi: It is the reference point between the PDN GW and the packet data network. Packet data network may be an operator external public or private packet data network or an intra operator packet data network, e.g. for provision of IMS services. This reference point corresponds to Gi for 3GPP accesses.

Rx: The Rx reference point resides between the AF and the PCRF in the 23.203 [6].

AF Application Function

AN Access Network

ARP Allocation and Retention Priority

AMBR Aggregate Maximum Bit Rate

ANDSF Access Network Discovery and Selection Function

BBERF Bearer Binding and Event Reporting Function

BSC Base Station Controller

BSS Base Station System

BSSGP Base Station System GPRS Protocol

BTS Base Transceiver Station

CBC Cell Broadcast Centre

CBE Cell Broadcast Entity

CCoA Collocated Care-of-address

CN Core Network

CSG Closed Subscriber Group

CSG ID Closed Subscriber Group Identity

DL TFT Down Link Traffic Flow Template

DSMIPv6 Dual-Stack MIPv6

eAN enhanced AN

ECGI E-UTRAN Cell Global Identifier

ECM EPS Connection Management

ECN Explicit Congestion Notification

eGTP enhanced Gateway Tunnelling Protocol

eNodeB enhanced Node B

EMM EPS Mobility Management

EPC Evolved Packet Core

EPS Evolved Packet System

ePDG Evolved Packet Data Gateway

E-RAB E-UTRAN Radio Access Bearer

E-UTRAN Evolved Universal Terrestrial Radio Access Network

FACoA Foreign Agent Care-of-Address

GBR Guaranteed Bit Rate

GGSN Gateway GPRS Support Node

GPRS General Packet Radio Service

GRE Generic Routing Encapsulation

GSM Global Communications System

GTP GPRS Tunneling Protocoll

GTP-C GTP control

GTP-U GTP user data tunneling

GUMMEI Globally Unique MME Identifier

GUTI Globally Unique Temporary Identity

GW Gateway

H ANDSF Home-ANDSF

HeNB Home eNode B

HeNB GW Home eNode B Gateway

HFN Hyper Frame Number

HO HandOver

HRPD High Rate Packet Data

HSS Home Subscriber Server

HSGW HRPD Serving GateWay

IE Information Element

IETF Internet Engineering Task Force

IMSI International Mobile Station Identity

IFOM IP Flow Mobility

IP Internet Protocol

IPMS IP Mobility management Selection

ISR Idle mode Signalling Reduction

LBI Linked EPS Bearer Id

L-GW Local GateWay

LIPA Local IP Access

LMA Local Mobility Anchor

LTE Long Term Evolution

MAG Mobile Access Gateway

MAPCON Multi Access PDN Connectivity

MBR Maximum Bit Rate

MIB Minimum Bit Rate

MIPv4 Mobile IP version 4

MIPv6 Mobile IP version 6

MME Mobility Management Entity

MMEC MME Code

MS Mobile Station

MTC Machine-Type Communications

M-TMSI M-Temporary Mobile Subscriber Identity

OFCS Offline Charging System

OMC-ID Operation and Maintenance Centre Identity

PCC Policy Control and Charging

PCF Packet Control Function

PCEF Policy and Charging Enforcement Function

PCRF Policy and Charging Rules Function

PDN Packet data Network

PDP Packet Data Protocol

PGW PDN Gateway

PDCP Packet Data Convergence Protocol

PMIP Proxy Mobile IP

PMIPv6 Proxy Mobile IP version 6

PSAP Public Safety Answering Point

PTI Procedure Transaction Id

QCI QoS Class Identifier

QoS Quality of Service

OCS Online Charging Systems

QSUP QoS based on Service information in User Plane protocol

RAN Radio Access Network

RFSP RAT/Frequency Selection Priority

RNAP Radio Access Network Application Part

RNC Radio Network Controller

SACC Service Aware Charging and Control

SAI Service Area Identifier

SGSN Serving GPRS Support Node

SGW Serving Gateway

SectorID Sector Address Identifier

S-TMSI S-Temporary Mobile Subscriber Identity

SDF Service Data Flow

SI Service Identification

SIPTO Selected IP Traffic Offload

TAC Tracking Area Code

TAD Traffic Aggregate Description

TAI Tracking Area Identity

TAU Tracking Area Update

TDF Traffic Detection Function

TEID Tunnel End Point Identifier

TI Transaction Identifier

TIN Temporary Identity used in Next update

TDF Traffic Detection Function

UE User Equipment

UDP User Datagram Protocol

UMTS Universal Mobile Telecommunications System

URRP-MME UE Reachability Request Parameter for MME

UL TFT UpLink Traffic Flow Template

ULR-Flags Update Location Request Flags

V ANDSF Visited-ANDSF

VS Vendor Specific

1. A method in a mobility management node for controlling resources of a radio terminal in a radio access node configured to operatively communicate user data between the radio terminal and a serving node, wherein the mobility management node is configured to operatively initiate an establishment of resources in the radio access node so as to enable communication of user data, and initiate a releasement of established resources in the radio access node so as to disable the communication of user data, wherein the method comprises:
obtaining service information indicating the frequency of at least one of the establishments or the releasements;
initiating an establishment of a new resource in the radio access node to enable a communication of user data between the radio terminal and the serving node;
determining an inactivation condition based on the service information, which inactivation condition enables the radio access node to determine a period after which the new resource is to be released; and
providing the inactivation condition to the radio access node so as to initiate a release of the new resource.

2. The method according to claim 1, wherein the service information is obtained based on at least one of the number of establishments or the number of releasements during a predetermined period.

3. The method according to claim 1, wherein the service information is obtained based on at least one of:
the number of establishments indicated by at least one of: the number of Service Request messages received by the mobility management node from the radio terminal node, or the number of UE Initial Context Request messages sent be the mobility management node to the radio access node, or the number of UE Initial Context Response messages received by the mobility management node from the radio access node, or the number of UE Context Modification messages sent by the mobility management node to the radio access node, or the number of UE Context Modification Response messages received by the mobility management node from the radio access node during the predetermined period; and
the number of releasements indicated by at least one off: the number of UE Context Release Request messages received by the mobility management node from the radio access node, or the number of UE Context Release Command messages sent by the mobility management node to the radio access node, or the number of UE Context Release Complete messages received by the mobility management node from the radio access node, or the number of Release Access Bearer Request messages sent by the mobility management node to the serving node, or the number of Release Access Bearer Response messages received by the mobility management node from the serving node.

4. The method according to claim 1, wherein the inactivation condition is determined such that the inactivation condition indicates an increased period when the service information corresponds to a frequency above a predetermined first threshold, and determined such that the inactivation condition indicates a decreased period when the service information corresponds to a frequency below a predetermined second threshold being lower than or equal to the first threshold.

5. The method according to claim 4, wherein the inactivation condition is determined such that the inactivation condition indicates an unchanged period when the service information corresponds to a frequency between the predetermined first threshold and the predetermined second threshold being lower than the first threshold.

6. The method according to claim 1, wherein the inactivation condition indicates a User Inactivity Timer.

7. A mobility management node configured to operatively control resources of a radio terminal in a radio access node that is configured to operatively communicate user data between the radio terminal and a serving node, wherein the mobility management node is further configured to operatively initiate an establishment of resources in the radio access node so as to enable communication of user data, and initiate a releasement of established resources in the radio access node so as to disable the communication of user data, where the mobility management node comprises processing circuitry configured to operatively:
obtain service information indicating the frequency of at least one of the establishments or the releasements;
initiate an establishment of a new resource in the radio access node to enable a communication of user data between the radio terminal and the serving node;
determine an inactivation condition based on the service information, which inactivation condition enables the radio access node to determine a period after which the new resource is to be released; and
provide the inactivation condition to the radio access node so as to initiate a release of the new resource.

8. The mobility management node according to claim 6, wherein the processing circuitry is further configured to operatively obtain the service information based on at least one of: the number of establishments or the number of releasements during a predetermined period.

9. The mobility management node according to claim 7, wherein the processing circuitry is further configured to operatively obtain the service information based on at least one of:
the number of establishments indicated by at least one of: the number of Service Request messages received by the mobility management node from the radio terminal node, or the number of UE Initial Context Request messages sent be the mobility management node to the radio access node, or the number of UE Initial Context Response messages received by the mobility management node from the radio access node, or the number of UE Context Modification messages sent by the mobility management node to the radio access node, or the number of UE Context Modification Response messages received by the mobility management node from the radio access node during the predetermined period; and
the number of releasements indicated by at least one of: the number of UE Context Release Request messages received by the mobility management node from the radio access node, or the number of UE Context Release Command messages sent by the mobility management node to the radio access node, or the number of UE Context Release Complete messages received by the mobility management node from the radio access node, or the number of Release Access Bearer Request messages sent by the mobility management node to the serving node, or the number of Release Access Bearer Response messages received by the mobility management node from the serving node.

10. The mobility management node according to claim 7, wherein the processing circuitry is further configured to operatively determine the inactivation condition such that the inactivation condition indicates an increased period when the service information corresponds to a frequency above a predetermined first threshold, and determine the inactivation condition such that the inactivation condition indicates a decreased period when the service information corresponds to a frequency below a predetermined second threshold being lower than or equal to the first threshold.

11. The mobility management node according to claim 9, wherein the processing circuitry is further configured to operatively determine the inactivation condition such that the inactivation condition indicates an unchanged period when the service information corresponds to a frequency between the predetermined first threshold and the predetermined second threshold being lower than the first threshold.

12. The mobility management node according to any one of claim 7, wherein the inactivation condition indicates a User Inactivity Timer.
